(19) United States
(12) Patent Application Publication
(10) Pub. No.: US 2022/0250226 A1
(43) Pub. Date: Aug. 11, 2022

(54) Combination Tool Assembly

(71) Applicant: Charles Doyle, Riverdale, GA (US)

(72) Inventor: Charles Doyle, Riverdale, GA (US)

(21) Appl. No.: 17/173,742

(22) Filed: Feb. 11, 2021

(51) Int. Cl. B25F 1/04; E04F 21/32; B44D 3/16; B67B 7/14

(52) U.S. Cl. CPC B25F 1/04; B67B 7/14; B44D 3/164; E04F 21/32

(57) ABSTRACT

A combination tool assembly for combining an opening tool with a putty knife includes a putty knife that has a handle and a blade integrated into the handle. An opening tool is slidably integrated into the handle. The opening tool is positionable in an extended position to pry a lid on a can and the opening tool is positionable in a retracted position for storage. A button is coupled to the opening tool and the button can be manipulated by a user for positioning the opening tool between the extended position and the retracted position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tool devices and more particularly pertains to a new tool device for combining an opening tool and a putty knife. The opening tool is slidably integrated into a handle of the putty knife such that the opening tool is positionable between an extended position and a retracted position.

### (2) Description of Related Art Including Information Disclosed Under 37 CFR 1.97 and 1.98

The prior art relates to tool devices including a variety of putty knives that each has unique structural elements in a blade for performing a variety of tasks with the blade. The prior art also discloses a putty knife that has a pair of screwdrivers each being pivotally coupled to the putty knife for positioning between a deployed position or a stored position. In no instance does the prior art disclose a putty knife that has an opening tool slidably integrated into a handle of the putty knife.

### BRIEF SUMMARY OF THE INVENTION

An embodiment of the disclosure meets the needs presented above by generally comprising a putty knife that has a handle and a blade integrated into the handle. An opening tool is slidably integrated into the handle. The opening tool is positionable in an extended position to pry a lid on a can and the opening tool is positionable in a retracted position for storage. A button is coupled to the opening tool and the button can be manipulated by a user for positioning the opening tool between the extended position and the retracted position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a combination tool assembly according to an embodiment of the disclosure.

FIG. 2 is a top view of an embodiment of the disclosure showing an opening tool in a retracted position.

FIG. 3 is a top view of an embodiment of the disclosure showing an opening tool in an extended position.

FIG. 4 is a right side view of an embodiment of the disclosure.

FIG. 5 is a cross sectional view taken along line 5-5 of FIG. 2 of an embodiment of the disclosure.

FIG. 6 is a cross sectional view taken along line 6-6 of FIG. 3 of an embodiment of the disclosure.

FIG. 7 is a perspective in-use view of an embodiment of the disclosure.

### DETAILED DESCRIPTION OF THE INVENTION

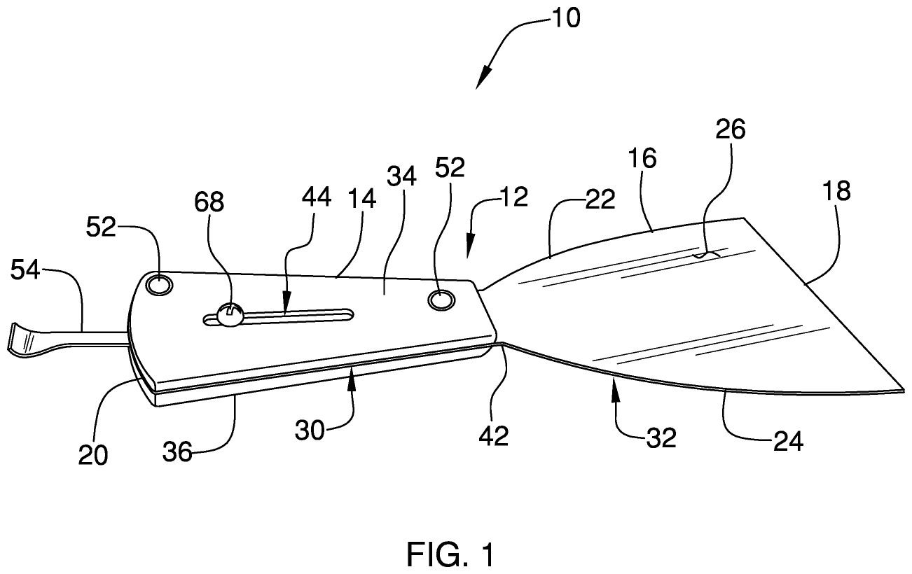

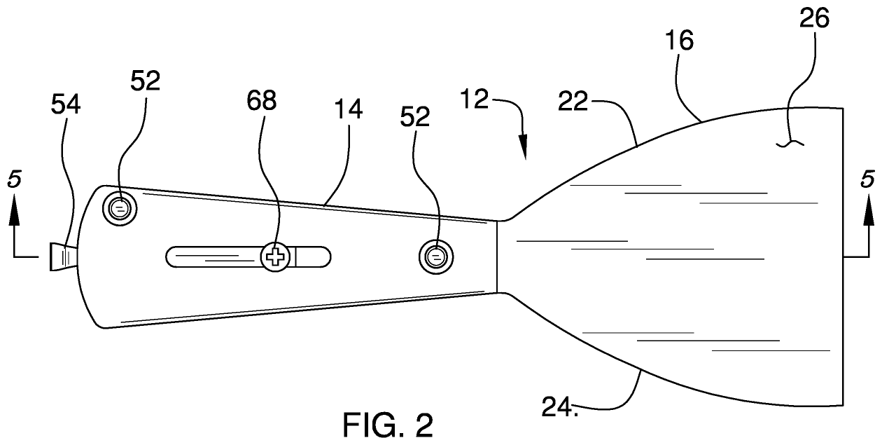

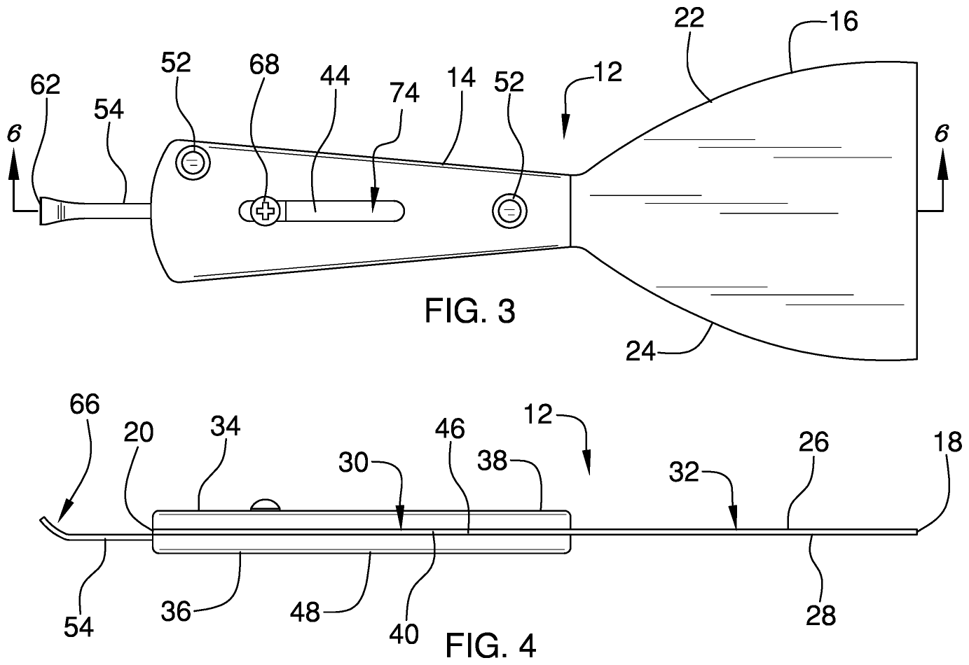

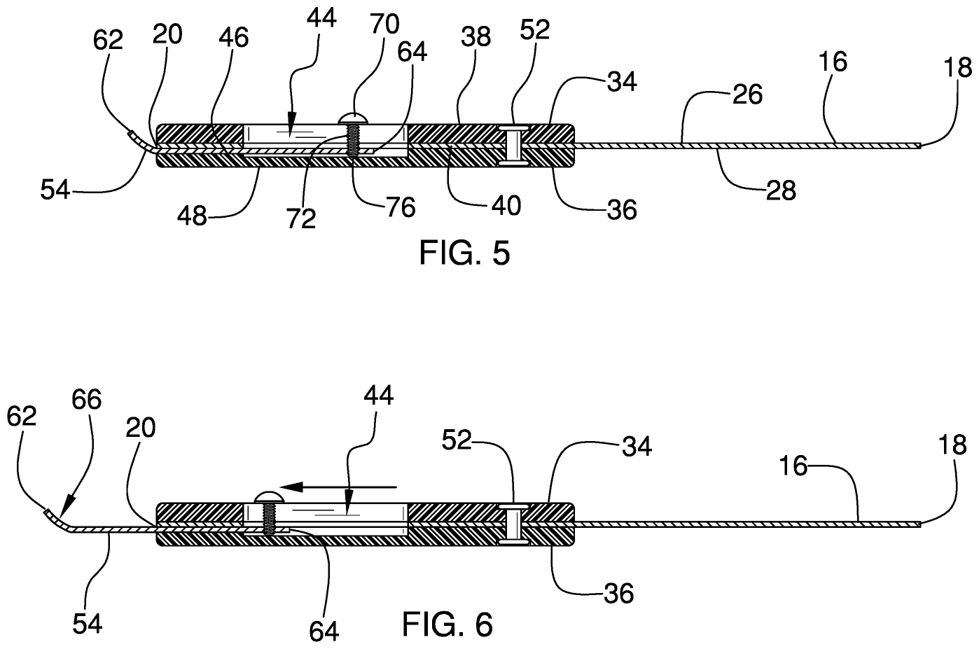

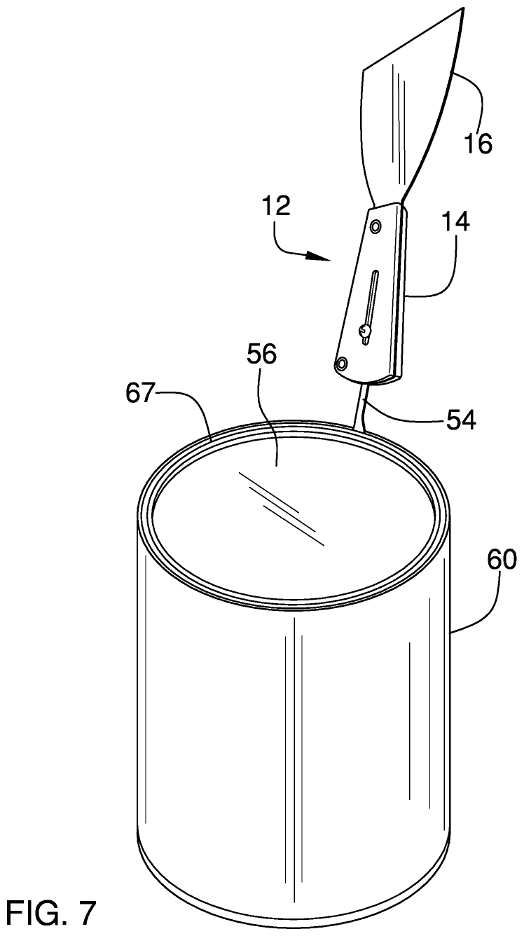

With reference now to the drawings, and in particular to FIGS. 1 through 7 thereof, a new tool device embodying the principles and concepts of an embodiment of the disclosure and generally designated by the reference numeral 10 will be described.

As best illustrated in FIGS. 1 through 7, the combination tool assembly 10 generally comprises a putty knife 12 that has a handle 14 and a blade 16 that is integrated into the handle 14. The handle 14 is gripped by a user thereby facilitating the blade 16 to be manipulated for assisting with painting work. The blade 16 has a front edge 18, a back edge 20, a first lateral edge 22, a second lateral edge 24, an upper surface 26 and a lower surface 28. The blade 16 is elongated between the front edge 18 and the back edge 20, and each of the first lateral edge 22 and the second lateral edge 24 has a first portion 30 extending from the back edge 20 toward the front edge 18. Additionally, each of the first lateral edge 22 and the second lateral edge 24 has a second portion 32 extending between the first portion 30 and the front edge 18. The second portion 32 of each of the first lateral edge 22 and the second lateral edge 24 curves outwardly between the first portion 30 and the front edge 18 such that the front edge 18 has a length that is greater than the length of the back edge 20.

The handle 14 comprises a first panel 34 and a second panel 36, and the first panel 34 has a top surface 38 and a bottom surface 40. The bottom surface 40 is positioned against the upper surface 26 of the blade 16, and the first panel 34 extends between the back edge 20 of the blade 16 and a terminal end 42 of the first portion 30 of each of the first lateral edge 22 and the second lateral edge 24 of the blade 16. The first panel 34 has a slot 44 extending through the top surface 38 and the bottom surface 40, and the slot 44 is elongated.

The second panel 36 has a top surface 46 and a bottom surface 48, and the top surface 46 of the second panel 36 is positioned against the lower surface 28 of the blade 16. Additionally, the second panel 36 is aligned with the first panel 34. The top surface 46 of the second panel 36 has a well 50 extending downwardly therein. Moreover, the well 50 is elongated and the well 50 is aligned with and is coextensive with the slot 44 in the first panel 34. A pair of fasteners 52 is provided and each of the fasteners 52 extends through the first panel 34, the blade 16 and the second panel 36 for fastening each of the first panel 34 and the second panel 36 to the blade 16. Each of the fasteners 52 may comprise a rivet, a screw or other type of penetrating fastener and the fasteners 52 may be positioned adjacent to opposing corners 53 of the handle 14

An opening tool 54 is slidably integrated into the handle 14 and the opening tool 54 is positionable in an extended position to pry a lid 56 on a can 60. The can 60 might be a paint can or other type of cylindrical container that has a lid 56 which can be pried off. The opening tool 54 is positionable in a retracted position for storage. The opening tool 54 has a first end 62 and a second end 64, and the opening tool 54 is elongated between the first end 62 and the second end 64. The opening tool 54 is curved adjacent to the first end 62 to define a grip 66 adjacent to the first end 62. In this way the grip 66 can 60 be positioned beneath a lip 67 of the lid 56 for prying the lid 56 upwardly. The opening tool 54 is slidably positioned in the well 50 in the top surface 38 of the second panel 36. Additionally, the opening tool 54 extends outwardly between the first panel 34 and the second panel 36 having the first end 62 being exposed.

A button 68 is coupled to the opening tool 54 and the button 68 can be manipulated by a user for positioning the opening tool 54 between the extended position and the retracted position. The button 68 includes a head 70 and a stem 72, and the stem 72 extends through the slot 44 in the first panel 34 and the stem 72 extends through the blade 16. The blade 16 has a channel 74 extending therethrough to facilitate the stem 72 to slide along the channel 74. The stem 72 has a distal end 76 with respect to the head 70 and the distal end 76 is coupled to the opening tool 54 at a point that is located adjacent to the second end 64 of the opening tool 54. Additionally, the head 70 extends outwardly from the slot 44 in the first panel 34 such that the head 70 can be engaged by the user.

In use, the handle 14 is gripped to employ the blade 16 for various duties during paint work or other activities. The button 68 is slid 56 rearwardly on the handle 14 to position the opening tool 54 in the extended position. In this way the grip defined on the opening tool 54 can 60 be positioned under the lip of the lid 56 for prying the lid 56 open. The button 68 is slid 56 forwardly on the handle 14 to position the opening tool 54 in the retracted position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A combination tool assembly for scraping paint and opening a paint can, said assembly comprising:
a putty knife having a handle and a blade being integrated into said handle wherein said handle is configured to be gripped by a user thereby facilitating said blade to be manipulated for assisting with painting work;
an opening tool being slidably integrated into said handle, said opening tool being positionable in an extended position wherein said opening tool is configured to pry a lid on a can, said opening tool being positionable in a retracted position for storage; and
a button being coupled to said opening tool wherein said button is configured to be manipulated by a user for positioning said opening tool between said extended position and said retracted position.

2. The assembly according to claim 1, wherein said blade has a front edge, a back edge, a first lateral edge, a second lateral edge, an upper surface and a lower surface, said blade being elongated between said front edge and said back edge, each of said first lateral edge and said second lateral edge having a first portion extending from said back edge toward said front edge, each of said first lateral edge and said second lateral edge having a second portion extending between said first portion and said front edge, said second portion of each of said first lateral edge and said second lateral edge curving outwardly between said first portion and said front edge such that said front edge has a length being greater than the length of said back edge.

3. The assembly according to claim 2, wherein said handle comprises a first panel and a second panel, said first panel having a top surface and a bottom surface, said bottom surface being positioned against said upper surface of said blade, said first panel extending between said back edge of said blade and a terminal end of said first portion of each of said first lateral edge and said second lateral edge of said blade, said first panel having a slot extending through said top surface and said bottom surface, said slot being elongated.

4. The assembly according to claim 3, wherein said second panel has a top surface and a bottom surface, said top surface of said second panel being positioned against said lower surface of said blade, said second panel being aligned with said first panel, said top surface of said second panel having a well extending downwardly therein, said well being elongated, said well being aligned with and being coextensive with said slot in said first panel.

5. The assembly according to claim 4, further comprising a pair of fasteners, each of said fasteners extending through said first panel, said blade and said second panel for fastening each of said first panel and said second panel to said blade.

6. The assembly according to claim 1, wherein said opening tool has a first end and a second end, said opening tool being elongated between said first end and said second end, said opening tool being curved adjacent to said first end to define a grip adjacent to said first end wherein said grip is configured to be positioned beneath a lip of the lid for prying the lip upwardly.

7. The assembly according to claim 6, wherein:
said handle comprises a first panel and a second panel, said second panel having a well extending into a top surface of said second panel; and
said opening tool is slidably positioned in said well in said top surface of said second panel, said opening tool extending outwardly between said first panel and said second panel having said first end being exposed.

8. The assembly according to claim 6, wherein:
said handle comprises a first panel and a second panel, said first panel having a slot extending therethrough; and
said button includes a head and a stem, said stem extending through said slot in said first panel, said stem extending through said blade, said blade having a channel extending therethrough to facilitate said stem to slide along said channel, said stem having a distal end with respect to said head, said distal end being coupled to said opening tool at a point being located adjacent to said second end of said opening tool, said head extending outwardly from said slot in said first panel wherein said head is configured to be engaged by the user.

9. A combination tool assembly for scraping paint and opening a paint can, said assembly comprising:
a putty knife having a handle and a blade being integrated into said handle wherein said handle is configured to be gripped by a user thereby facilitating said blade to be manipulated for assisting with painting work, said blade having a front edge, a back edge, a first lateral edge, a second lateral edge, an upper surface and a lower surface, said blade being elongated between said front edge and said back edge, each of said first lateral edge and said second lateral edge having a first portion extending from said back edge toward said front edge, each of said first lateral edge and said second lateral edge having a second portion extending between said first portion and said front edge, said second portion of each of said first lateral edge and said second lateral edge curving outwardly between said first portion and said front edge such that said front edge has a length being greater than the length of said back edge, said handle comprising a first panel and a second panel, said first panel having a top surface and a bottom surface, said bottom surface being positioned against said upper surface of said blade, said first panel extending between said back edge of said blade and a terminal end of said first portion of each of said first lateral edge and said second lateral edge of said blade, said first panel having a slot extending through said top surface and said bottom surface, said slot being elongated, said second panel having a top surface and a bottom surface, said top surface of said second panel being positioned against said lower surface of said blade, said second panel being aligned with said first panel, said top surface of said second panel having a well extending downwardly therein, said well being elongated, said well being aligned with and being coextensive with said slot in said first panel;
a pair of fasteners, each of said fasteners extending through said first panel, said blade and said second panel for fastening each of said first panel and said second panel to said blade;
an opening tool being slidably integrated into said handle, said opening tool being positionable in an extended position wherein said opening tool is configured to pry a lid on a can, said opening tool being positionable in a retracted position for storage, said opening tool having a first end and a second end, said opening tool being elongated between said first end and said second end, said opening tool being curved adjacent to said first end to define a grip adjacent to said first end wherein said grip is configured to be positioned beneath a lip of the lid for prying the lip upwardly, said opening tool being slidably positioned in said well in said top surface of said second panel, said opening tool extending outwardly between said first panel and said second panel having said first end being exposed; and
a button being coupled to said opening tool wherein said button is configured to be manipulated by a user for positioning said opening tool between said extended position and said retracted position, said button including a head and a stem, said stem extending through said slot in said first panel, said stem extending through said blade, said blade having a channel extending therethrough to facilitate said stem to slide along said channel, said stem having a distal end with respect to said head, said distal end being coupled to said opening tool at a point being located adjacent to said second end of said opening tool, said head extending outwardly from said slot in said first panel wherein said head is configured to be engaged by the user.
